(19) United States
(12) Patent Application Publication
(10) Pub. No.: US 2018/0047119 A1
(43) Pub. Date: Feb. 15, 2018

(54) Contract management system, apparatus, and method

(71) Applicant: Fair Contract, Inc., New York, NY (US)

(72) Inventor: Steven H. Robinson, New York, NY (US)

(21) Appl. No.: 15/449,305

(22) Filed: Mar. 3, 2017

Related U.S. Application Data
(60) Provisional application No. 62/372,585, filed on Aug. 9, 2016.

(51) Int. Cl. G06Q 50/18

(52) U.S. Cl. CPC G06Q 50/18

(57) ABSTRACT

A contract management system includes a contract management server and a contract management device. A contract management server includes a terms and conditions appendix section store, an archive manager, and a contract manager. A contract manager can incorporate a terms and conditions appendix section into a subscriber form contract, thereby creating a modified subscriber contract. A contract partner can accept a modified subscriber contract, thereby creating a completed contract. A contract management device can prompt a contract partner to accept an amendment to the completed contract when an updated version of the terms and conditions appendix section is released. Further disclosed is a computer-implemented method for managing contracts, including a method for updating and archiving terms and conditions appendix sections.

### CROSS-REFERENCE TO RELATED APPLICATIONS

This application claims the benefit of U.S. Provisional Application No. 62/372,585, filed Aug. 9, 2016.

### FIELD OF THE INVENTION

The present invention relates generally to the field of managing contracts, and more particularly to methods and systems for managing contractual terms and conditions.

### BACKGROUND OF THE INVENTION

Contracts generally comprise a variety of sections intended to specify the nature of the agreement. Some sections can include language detailing business terms that are relevant solely to specific individual contracts, such as payment, quantity, and delivery/performance dates. Additionally, contracts usually include more general sections providing terms and conditions, covering topics such as confidentiality, limitation of liability, indemnification, term, termination and alternative dispute resolution.

In some form contracts, known as a contracts of adhesion, the generalized terms and conditions are written by one of the parties and are non-negotiable. Contracts of this type provide terms and conditions that are often written to heavily favor the author at the expense of the less sophisticated party, and are typically used for mass market contracts or when there is a large difference in the level of sophistication between the contracting parties in the field covered by the contract. It can be difficult for an unsophisticated contracting party to understand the terms and conditions to which they are agreeing.

Individually negotiated contracts providing more even handed terms are commonly obtained by engaging legal counsel, but the time and expense required to do so are unsuitable for broad categories of common transactions, including those involving smaller dollar amounts or evolving business opportunities.

As such, considering the foregoing, it may be appreciated that there continues to be a need for novel and improved systems, apparatuses and methods for incorporating a standardized set of terms and conditions into a form contract, and for amending a form contract when the standardized terms and conditions are updated.

### SUMMARY OF THE INVENTION

The foregoing needs are met, to a great extent, by the present invention, wherein in aspects of this invention, enhancements are provided to the existing model of managing contracts.

In an aspect, a contract management system can include:
a contract management server, which can be configured to store a terms and conditions appendix section;
wherein the contract management server can be configured to create a subscriber form contract, and receive an instantiated terms and conditions appendix section, such that the contract management server can be configured to incorporate the terms and conditions appendix section into the subscriber form contract, thereby creating a modified subscriber contract;
wherein the contract management server can be configured to create a completed contract when the modified subscriber contract is accepted by a contract partner.

In related aspects, the contract management server can be configured to incorporate the terms and conditions appendix section into the subscriber contract by either adding a sentence which references the terms and conditions appendix section, or including the full text of the terms and conditions appendix section in the subscriber form contract.

In related aspects, the system can include a contract management device which can be configured to allow a contract partner and/or a subscriber to accept, review and enter into the modified subscriber contract.

In related aspects, the contract management server can be configured to prompt the contract partner and/or the subscriber to review an amendment, and subject to that review, accept the amendment, and thereby enter into the amendment to the completed contract.

In an aspect a contract management system can include:
a) a terms and conditions server, which can be configured to store a terms and conditions appendix section; and
b) a subscriber server, which can be configured to store a subscriber form contract, wherein the subscriber server is connected to the terms and conditions server;
wherein the subscriber server can be configured to receive an instantiated terms and conditions appendix section, such that the subscriber server is configured to incorporate the terms and conditions appendix section into the subscriber form contract, thereby creating a modified subscriber contract;
wherein the subscriber server can be configured to create a completed contract when the modified subscriber contract is accepted, and thereby entered into, by a contract partner.

In related aspects, a computer-implemented method for managing contracts can include:
a) selecting a desired subscriber form contract;
b) adding language to the subscriber form contract incorporating a current version of a terms and conditions appendix section into the subscriber form contract, thereby creating a modified subscriber contract;
c) presenting the modified subscriber contract to a subscriber and a contract partner for review; and
d) accepting the modified subscriber contract by the contract partner, thereby creating a completed contract.

In related aspects, the method can include prompting the contract partner to review and accept, and thereby enter into, an amendment to the completed contract.

In related aspects, the method can include adding language to the modified subscriber contract which acts to automatically update the completed agreement when an update version of the terms and conditions appendix section is released.

In related aspects, the method can include:
a) reviewing the current version of the terms and conditions appendix section;
b) revising the current version of the terms and conditions appendix section, thereby creating an updated version of the terms and conditions appendix section;
c) releasing the updated version of the terms and conditions appendix section; and
d) archiving the current version of the terms and conditions appendix section.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic diagram illustrating a contract management system, according to an embodiment of the invention.

FIG. 2 is a schematic diagram illustrating a contract management server, according to an embodiment of the invention.

FIG. 3 is a schematic diagram illustrating a contract management device, according to an embodiment of the invention.

FIG. 4 is a flowchart illustrating steps that may be followed, in accordance with one embodiment of a method or process for managing contracts.

FIG. 5 is a flowchart illustrating steps that may be followed, in accordance with one embodiment of a method or process for managing contracts.

FIG. 6 is a flowchart illustrating steps that may be followed, in accordance with one embodiment of a method or process for managing contracts.

FIG. 7 is a schematic diagram illustrating a contract management system, according to an embodiment of the invention.

FIG. 8 is a schematic diagram illustrating a subscriber server, according to an embodiment of the invention.

FIG. 9 is a schematic diagram illustrating a terms and conditions server, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

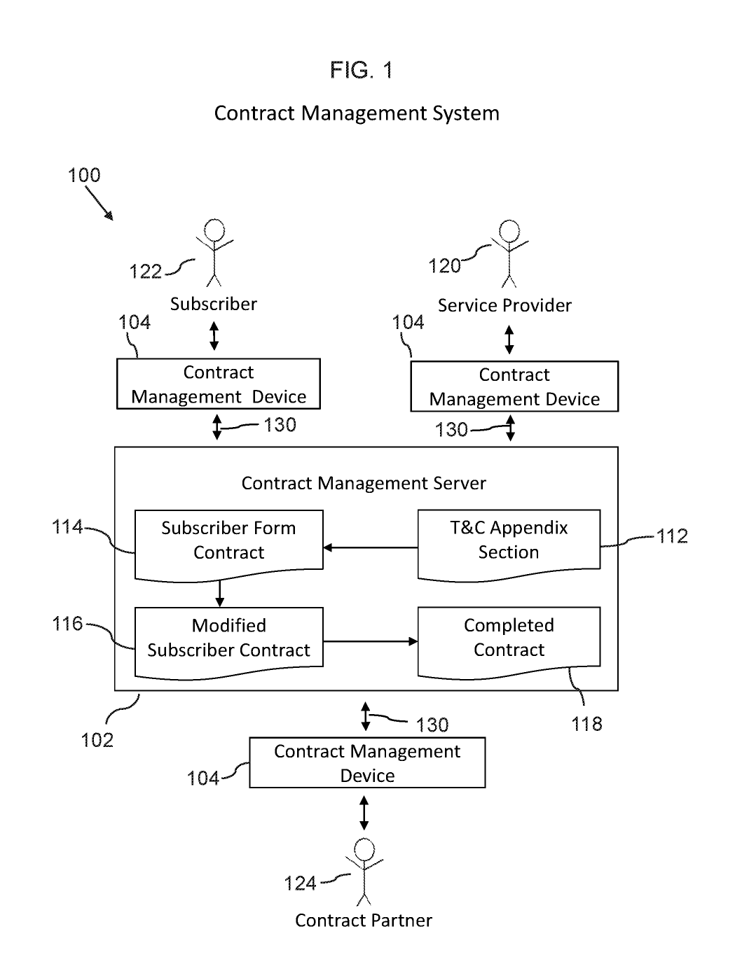

In the following, we describe the structure of an embodiment of a contract management system 100 with reference to FIG. 1, in such manner that like reference numerals refer to like components throughout; a convention that we shall employ for the remainder of this specification.

In an embodiment a contract management system 100 can comprise:
a contract management server 102, which can be configured to store a template terms and conditions appendix section 112;
wherein the contract management server 102 can be configured to create a subscriber form contract 114, such that the contract management server 102 can be configured to incorporate the terms and conditions appendix section 112 into the subscriber form contract 114, thereby creating a modified subscriber contract 116;
wherein the contract management server 102 can be configured to create a completed contract 118 when the modified subscriber contract 116 is accepted by a contract partner 124.

In a related embodiment, a subscriber 122 can be a person or business entity who has entered into a business relationship with a service provider 120. The terms and conditions appendix section 112 can be copyrighted material owned by the service provider 120. Furthermore, the business relationship between the service provider 120 and the subscriber 122 can include a subscription, or license, from the service provider 120 to the subscriber 122 to utilize the terms and conditions appendix section 112 in contracts and agreements used by the subscriber 122, such as the subscriber form contract 114.

In certain embodiments, both the subscriber 122 and the contract partner 124 can be contracting parties to the completed contract 118.

In a related embodiment, the terms and conditions appendix section 112 (shown in FIG. 1 as the T&C Appendix Section 112) can be a standardized set of terms and conditions written by a third party. The terms and conditions appendix section 112 can be written with a goal of creating a fair and even completed contract 118 between the subscriber 122 and the subscriber's contract partner 124, particularly in instances where the contract partner 124 is the less sophisticated party. When incorporated into a preexisting contract, such as the subscriber form contract 114, the terms and conditions appendix section 112 can function as the terms and conditions of the subscriber form contract 114.

In a related embodiment, as shown in FIG. 1, terms and conditions appendix section 112 can be stored on the contract management server 102, which can be accessed and controlled by the service provider 120 via a contract management device 104. The contract management device 104 can be configured to communicate with the contract management server 102 over a network 130.

In a related embodiment, as shown in FIG. 1, in the event that a subscriber 122 does not have its own server, the service provider 120 can offer a turn-key service by hosting and storing the subscriber form contract 114 and/or the modified subscriber contract 116 on a contract management server 102. The contract management server 102 can be accessed by the subscriber 122 and the contract partner 124 via a contract management device 104.

In a related embodiment, as shown in FIG. 1, the contract management server 102 can be configured to store the completed contract 118, which can increase the ease with which the complete contract 118 can be amended by the contracting parties, as is described hereinafter.

In a related embodiment, the contract management server 102 can be configured to incorporate the template terms and conditions appendix section 112 into the subscriber form contract 114 by adding language to the subscriber form contract, such that the added language refers to the template terms and conditions appendix section. The added language can, for example, be an additional sentence.

In a related embodiment, the contract management server 102 can be configured to incorporate the template terms and conditions appendix section 112 into the subscriber form contract 114 by creating an instantiated terms and conditions appendix section 112, which is a copy of the template terms and conditions appendix section 112, such that the contract management server 102 is configured to add the instantiated terms and conditions appendix section 112 to the subscriber form contract 114.

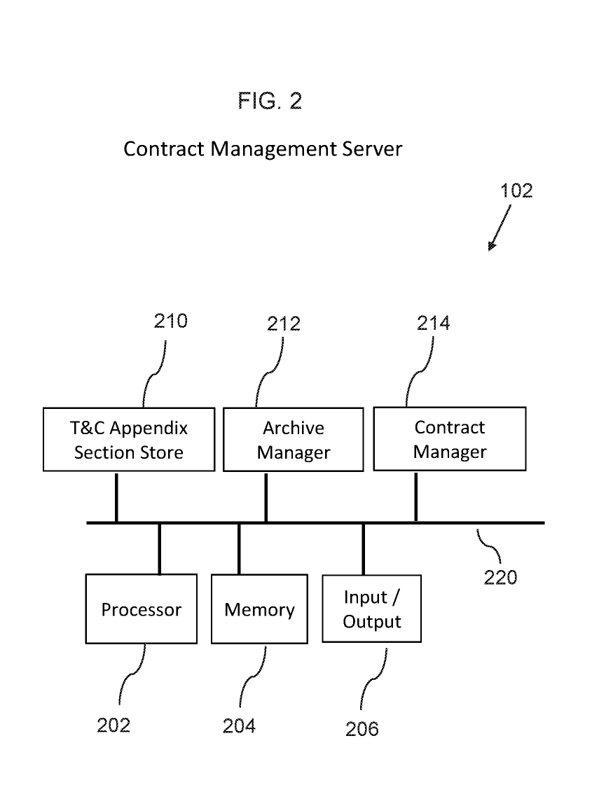

In a related embodiment, as shown in FIG. 2, a contract management server 102 can comprise:
a) a processor 202;
b) a non-transitory memory 204;
c) an input/output component 206;
d) a terms and conditions appendix section store 210, which can be configured to store a current version of the template terms and conditions appendix section 112;
e) an archive manager 212, which can be configured to store previous versions of the template terms and conditions appendix section 112; and
f) a contract manager 214; all connected via
g) a data bus 220.

In a related embodiment, the service provider 120 can control the contract management server 102 via a contract management device 104 and thereby maintain the archive manager 212, which can store archived previous versions of the terms and conditions appendix sections 112, as will be described in more detail hereinafter. The archive manager 212 can be configured as a database which can store previous versions of the terms and conditions appendix sections 112, along with unique identifying information correlated to each version, such as a version number string.

In a related embodiment, the terms and conditions appendix section store 210 can be configured to store a plurality of different current drafts of the terms and conditions appendix section 112, where each current draft of the terms and conditions appendix section 112 corresponds to a different business industry (pet grooming, lawn care, legal services, etc.) which requires specific language tailored to that industry. The subscriber form contract 114 can incorporate a specific current draft of the terms and conditions appendix section 112 depending on the type of business conducted by the subscriber 122 and the nature of the agreement contemplated by the subscriber form contract 114. The terms and conditions appendix section store 210 can be configured to store each current draft of the terms and conditions appendix section 112 in a database, along with unique identifying information correlated to each version, such as a version number string.

In a related embodiment, the contract manager 214 can be configured to create a subscriber form contract 114 on behalf of the subscriber 122. In certain embodiments, the contract manager 214 can be configured to allow a subscriber 122 to use a contract management device 104 to create a subscriber form contract 114, which can then be hosted and/or stored by the contract manager 214. In other embodiments, the subscriber 122 can upload a pre-existing subscriber form contract 114 to the contract management server 102 via a contract management device 104.

In a related embodiment, the contract manager 214 can be configured to receive an instantiated terms and conditions appendix section 112 from the terms and conditions appendix section store 210. In certain embodiments, the subscriber 122 can select a desired version of the terms and condition appendix section 112 to instantiate based on the type of business covered by the subscriber form contract 114.

In a related embodiment, the contract manager 214 can be configured to instantiate the terms and conditions appendix section 112 in the subscriber form contract 114 by modifying the subscriber form contract 114 to include a sentence referencing the terms and conditions appendix section 112 stored on the contract management server 102, for example, by a version number string and/or date. By the language used in the included sentence, the instantiated terms and conditions appendix section 112 can be incorporated into the subscriber form contract 114, thereby causing the terms and conditions appendix section 112 to function as the terms and conditions of the newly created modified subscriber contract 116 (e.g., “This contract hereby employs FairContract^{SM} Terms & Conditions v3.04.027 to govern the rights and obligations of the parties”).

In a related embodiment, the contract manager 214 can be configured to instantiate the terms and conditions appendix section 112 by adding the full text of the terms and conditions appendix section 112 to the subscriber form contract 114. For example, the modified subscriber contract 116 can include the terms and conditions appendix section 112 in a subsection or an appendix of the modified subscriber contract 116.

In a related embodiment, the contract manager 214 can be configured to instantiate and incorporate a current version of the terms and conditions appendix section 112 from the terms and conditions appendix section store 210. In certain embodiments, the contract manager 214 can be configured to instantiate and incorporate a previous version of the terms and conditions appendix section 112 from the archive manager 212, depending on the preference of the contracting parties.

In a related embodiment, the contract manager 214 can be configured to allow users, such as the subscriber 122 and the contract partner 124, to view both current and archived versions of the terms and conditions appendix sections 112 via a network 130.

In a related embodiment, the contract manager 214 can be configured to replace the current version of the template terms and conditions appendix section in the terms and conditions appendix section store 210 with an updated version of the template terms and conditions appendix section; wherein the contract manager can be configured to archive the current version of the template terms and appendix section in the terms and conditions appendix section store 210, in communication with the archive manager 212.

In a related embodiment, the contract manager 214 can be configured to receive an acceptance input from the contract partner 124 to enter into an amendment to an existing completed contract when the current version of the terms and conditions appendix section is updated, such that the contract manager 214 is configured to update the completed contract with the new, amended terms and conditions, to create an amended contract, when the contract manager receives the acceptance input.

In a related embodiment, the contract manager 214 can be configured to automatically update the completed contract with an updated version of the terms and condition appendix section when the current version of the terms and conditions appendix section is updated.

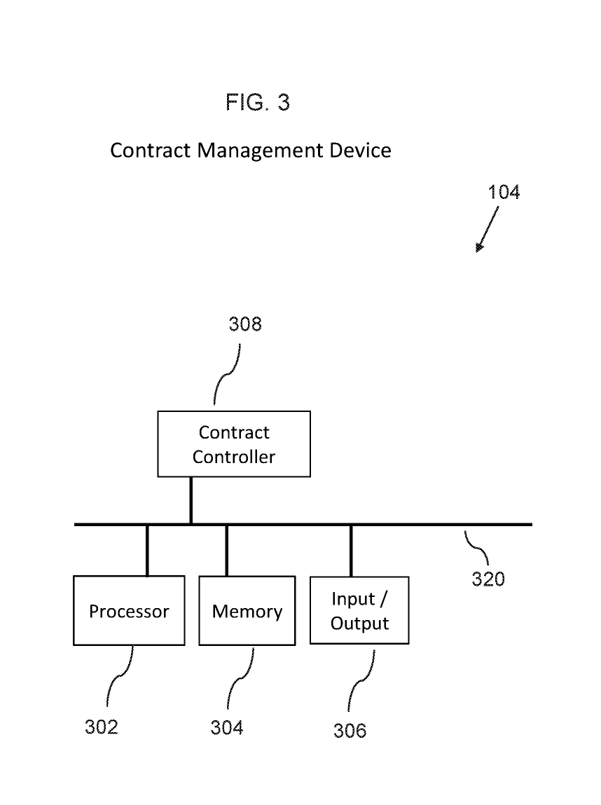

In a related embodiment, as shown in FIG. 3, a contract management device 104 can comprise:
a) a processor 302;
b) a non-transitory memory 304;
c) an input/output 306; and
d) a contract controller 308; all connected via
e) a data bus 320.

In a related embodiment, the contract controller 308 can be configured to enable the contract partner to view the modified subscriber contract and the completed contract.

In a related embodiment, both the subscriber 122 and the contract partner 124 can utilize the contract management device 104 to connect to and communicate with the contract management server 102 via a network 130, thereby allowing the contract parties to view the modified subscriber contract 116 prior to acceptance.

In a related embodiment, the contract partner 124 can use the contract management device 104 to electronically accept, i.e. agree to and enter into, the modified subscriber contract 116 via the contract controller 308. If accepted, the accepted modified subscriber contract 116 thereby becomes the completed contract 118, with the terms and conditions appendix section 112 functioning as the terms and conditions of the completed contract 118, as previously discussed.

In a related embodiment, the contract controller 308 can be configured to receive a contract accept input from the contract partner 124, when the contract partner 124 accepts the modified subscriber contract.

In a related embodiment, the contract controller 308 can be configured to receive a subscriber accept input from the subscriber 122 when the subscriber 122 accepts the modified subscriber contract.

In a related embodiment, the contract controller 308 can be configured to receive a partner amendment accept input from the contract partner 124, when the contract partner 124 accepts an amendment to the completed contract.

In a related embodiment, the contract controller 308 can be configured to receive a subscriber amendment accept input from the subscriber when the subscriber accepts an amendment to the completed contract.

In certain embodiments, the modified subscriber contract 116 immediately becomes the completed contract 118 upon acceptance by the contract partner 124. In other embodiments, the modified subscriber contract 116 must be accepted by both the subscriber 122 and the contract partner 124 before it becomes the completed contract 118.

In a related embodiment, the contract controller 308 can be configured to facilitate acceptance of the modified subscriber contract 116 using any suitable method, including a digital stylus, an electronic signature, pressing a virtual button on a smartphone screen, fingerprint recognition, and facial recognition.

In a related embodiment, the terms and conditions appendix section 112, the subscriber form contract 114, the modified subscriber contract 116, and the completed contract 118 can each be stored and processed as a data structure, for example as an XML or XML DOM object, text, or composite data structure, any of which can be output to a text or document representation, such as PDF.

In a related embodiment, the service provider 120 can utilize the contract management device 104 to connect with the contract management server 102. The contract controller 308 can be configured to communicate electronically with the contract manager 214, allowing the contract manager 214 to view and update versions of the terms and conditions appendix section 112 stored on the contract management server 102 as well as move versions of the terms and conditions appendix section 112 from the terms and conditions appendix section store 210 to the archive manager 212, and vice versa.

In related embodiments, the contract management device 104 can include configurations such as:
a) a web application, executing in a Web browser;
b) a tablet app, executing on a tablet device, such as for example an Android or iOS tablet device;
c) a mobile app, executing on a mobile device, such as for example an Android phone or iPhone, or any wearable mobile device;
d) a desktop application, executing on a personal computer, or similar device; or
e) an embedded application, executing on a processing device, such as for example a smart TV, a game console or other system.

It shall be understood that an executing instance of an embodiment of the contract management system 100, as shown in FIG. 1, can include a plurality of contract management devices 104, which are each tied to one or more contract partners 124 or subscribers 122.

Similarly, an executing instance of an embodiment of the contract management system 100, as shown in FIG. 1, can include a plurality of contract management servers 102.

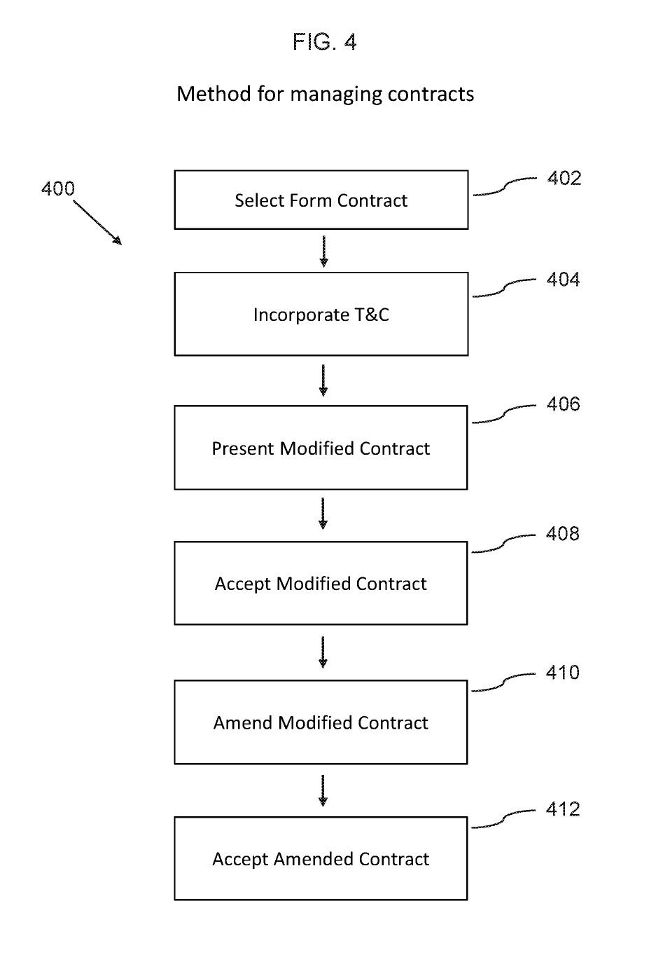

In a related embodiment, as shown in FIG. 4, a computer-implemented method for managing contracts 400 can include:
a) Selecting form contract 402, comprising selecting a desired subscriber form contract;
b) Incorporating terms and conditions 404, comprising adding language incorporating a current version of a terms and conditions appendix section into the subscriber form contract, thereby creating a modified subscriber contract;
c) Presenting a modified contract 406, comprising presenting the modified subscriber contract to a subscriber and a contract partner for review;
d) Accepting a modified contract 408, comprising receiving acceptance of the modified subscriber contract by the contract partner 124, thereby creating a completed contract;
e) Amending modified contract 410, comprising prompting the contract partner 124 to review an amendment to the completed contract when an updated version of the terms and conditions appendix section is released; and
f) Accepting amended contract 412, comprising receiving acceptance from the contract partner 124 of the amendment to the completed contract, wherein the current version of the terms and conditions appendix section is replaced by the updated version of the terms and conditions appendix section.

In a related embodiment, the contract partner 124 can accept the modified subscriber contract 116 by communicating with the contract manager 214 via the contract controller 308.

In a further related embodiment, the subscriber 124 can accept the modified subscriber contract 116 by communicating with the contract manager 214 via the contract controller 308, prior to obtaining contract partner 124 acceptance, such that the contract partner 124 can accept the modified subscriber contract 116 only when the modified subscriber contract 116 has been accepted by the subscriber 124.

In a related embodiment, the completed contract 118 is created when only the contract partner 124 accepts the modified subscriber contract 116. For example, the modified subscriber contract 116 can be configured as an offer made by the subscriber that can be accepted by the contract partner 124 (e.g., a form to be filled out by the contract partner 124 using a Web browser). However, in certain embodiments, the completed contract is not created until both the contract partner 124 and the subscriber 122 accept the modified subscriber contract 116.

In a related embodiment, the subscriber 122 can accept, and thereby agree to, the modified subscriber contract 116 via the contract controller 308, as previously described.

In a related embodiment, acceptance of an amendment to the completed contract 118, such as an agreement to update the terms and conditions to an updated version of the terms and conditions appendix section 112, can be performed via the contract management devices 104. In certain embodiments, the contract controller 308 can be configured such that amendments can be accepted in a manner that is similar to how the modified subscriber contract 116 is accepted. In certain embodiments, accepting an amendment can be performed merely by pressing a button on a smartphone screen, similar to how apps can be updated on smartphones.

In a related embodiment, both the subscriber 122 and the contract partner 124 can be prompted to accept an amendment to the completed contract 118. For example, the contract management server 102 can send out prompts to the subscriber 122 and the contract partner 124 via the contract management devices 104, notifying the contracting parties that the version of the terms and conditions appendix section 112 incorporated in their completed contract 118 has been updated and encouraging the contracting parties to review and, subject to their approval, accept the amendment to the completed contract 118, to incorporate the updated version of the terms and conditions appendix section 112.

In certain embodiments, only the contract partner 124 needs to accept an amendment in order to amend the completed contract 118. For example, the subscriber 122 can choose to offer an amendment to the completed contract 118 to, for example, incorporate an updated version of the terms and conditions appendix section 112. The contract partner 124 can then unilaterally accept the amendment.

In a related embodiment, the completed contract 118 need not be amended by the contract parties, even after an updated version of the terms and conditions appendix section 112 is released.

In a related embodiment, the computer-implemented method for managing contracts 400 can further include:
a) prompting the contract partner to accept an amendment to the completed contract when an updated version of the terms and conditions appendix section is released; and
b) receiving acceptance to an amendment to the completed contract from the contract partner, and then replacing the current version of the terms and conditions appendix section in the completed contract with the updated version of the terms and conditions appendix section.

In a related embodiment, the computer-implemented method for managing contracts 400 can further include:
a) adding language to the subscriber form contract to specify that an updated version of the terms and conditions appendix section is automatically incorporated into the completed contract upon release; and
b) automatically incorporating the updated version of the terms and conditions appendix section into the completed contract.

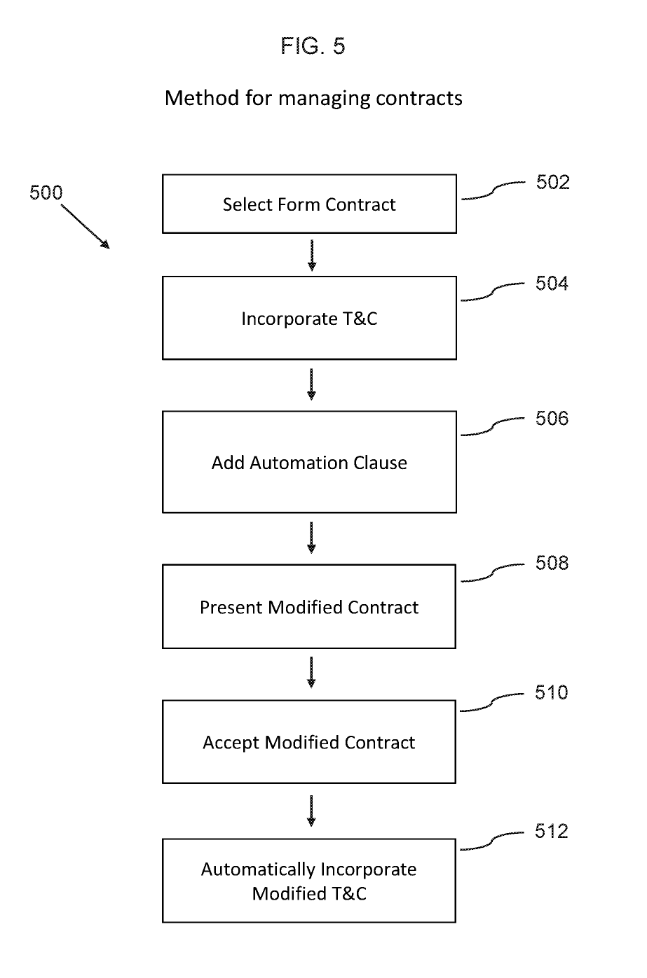

In a related embodiment, as shown in FIG. 5, a computer-implemented method for managing contracts 500 can comprise:
a) Selecting form contract 502, comprising selecting a desired subscriber form contract;
b) Incorporating terms and conditions 504, comprising adding language to the subscriber form contract incorporating a current version of a terms and conditions appendix section into the subscriber form contract 504, thereby creating a modified subscriber contract;
c) Adding automation clause 506, comprising adding language to the subscriber form contract whereby an updated version of the terms and conditions appendix section is automatically incorporated into the completed contract upon release;
d) Presenting modified contract 508, comprising presenting the modified subscriber contract to the subscriber and contract partner for review;
e) Accepting modified contract 510, comprising receiving acceptance of the modified subscriber contract from the contract partner, and then creating a completed contract; and
f) Automatically incorporating modified terms and conditions 512, comprising automatically incorporating an updated version of the terms and conditions appendix section into the completed contract.

In a related embodiment, modified subscriber contract 116 can be configured to automatically incorporate updated versions of the terms and conditions appendix section 112 by the inclusion of a sentence specifically stating that such is the desire of the contracting parties (e.g., “This contract hereby automatically incorporates the most recent release of FairContract^{SM} Terms & Conditions v3 as the governing Terms and Conditions . . . ”). Such a facility for automatically updating completed contracts 118 may be useful in industries that are relatively new and changing quickly, such as internet marketing or ride sharing services.

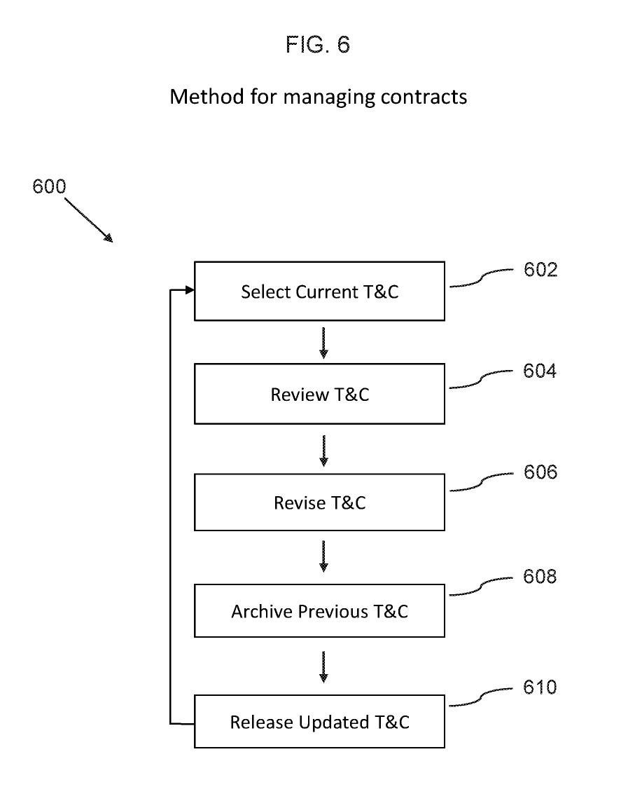

In a related embodiment, as shown in FIG. 6, a computer-implemented method for managing contracts 600 can comprise:
a) Selecting current terms and conditions 602, comprising selecting a current version of a terms and conditions appendix section;
b) Reviewing terms and conditions 604, comprising reviewing the current version of the terms and conditions appendix section;
c) Revising terms and conditions 606, comprising revising the current version of the terms and conditions appendix section, thereby creating an updated version of the terms and conditions appendix section;
d) Archiving current terms and conditions 608, comprising archiving the current version of the terms and conditions appendix section; and
e) Releasing updated terms and conditions 610, comprising releasing the updated version of the terms and conditions appendix section, such that the updated version of the terms and conditions appendix section becomes the current version of the terms and conditions appendix section.

In a related embodiment, the computer-implemented method for archiving contracts 600 begins by a selecting a current version of the terms and conditions appendix section 112 from the terms and conditions appendix section store 210 for review. The terms and conditions appendix section 112 can be reviewed by the service provider 120 and/or one or more professionals or experts in the industry to which the selected version of terms and conditions appendix section 112 pertains. The terms and conditions appendix section 112 can be reviewed with the goal of keeping the terms and conditions appendix section 112 in line with evolution in the industry, statutory and regulatory changes, and input from contracting parties.

In a related embodiment, once the review has been performed, the terms and conditions appendix section 112 can be revised and updated accordingly, thereby creating an updated version of the terms and conditions appendix section 112. The updated version of the terms and conditions appendix section 112 can be released and stored in the terms and conditions appendix section store 210. Thereafter, the current version of the terms and conditions appendix section 112 becomes a previous version, and can be moved by the contract manager 214 to the archive manager 212, where the previous version can be placed in a database along with an identifying version number string. Previous versions of terms and conditions appendix sections 112 can be available for viewing to parties such as the subscriber 122 and the contract partner 124 via contract management devices 104.

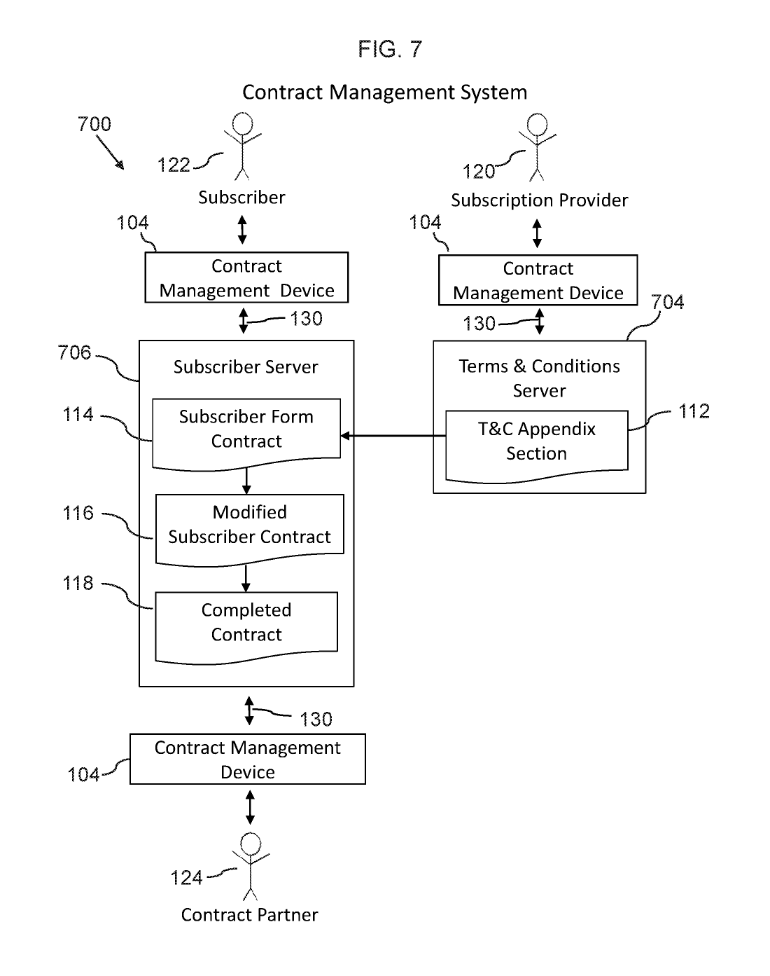

In a related embodiment, as shown in FIG. 7, a contract management system 700 can comprise:
a) a terms and conditions server 704, which can be configured to store a template terms and conditions appendix section 112; and
b) a subscriber server 706, which can be configured to create and store a subscriber form contract 114, wherein the subscriber server 706 is in communication with the terms and conditions server 704;
wherein the subscriber server 706 is configured to receive an instantiated terms and conditions appendix section 112, which is a copy of the template terms and conditions appendix section, such that the subscriber server 706 is configured to incorporate the terms and conditions appendix section 112 into the subscriber form contract 114, thereby creating a modified subscriber contract 116;
wherein the subscriber server 706 is configured to create a completed contract 118 when the modified subscriber contract 116 is accepted by a contract partner 124.

In a related embodiment, a subscriber 122 can choose to utilize a subscriber server 706 to implement the system 700. The subscriber server 706 can be configured to host and/or store the subscriber form contract 114 and the modified subscriber contract 116. In certain embodiments, the subscriber server 706 can also be configured to store the completed contract 118.

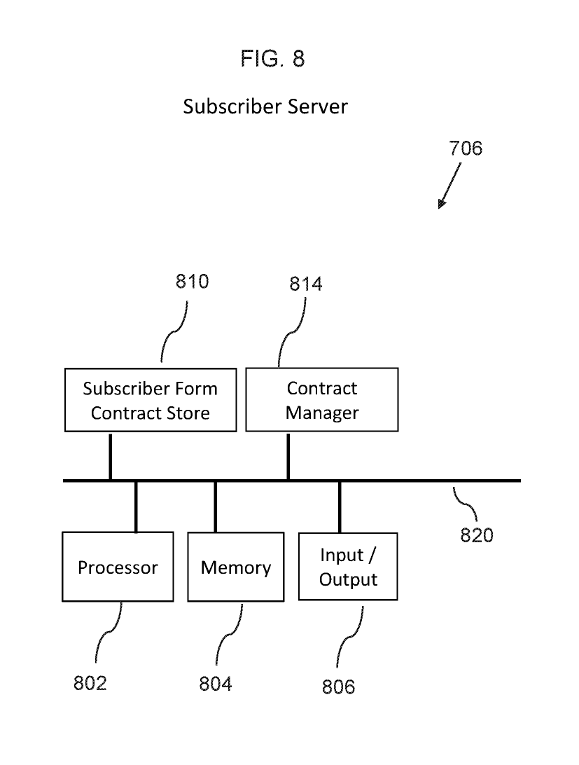

In a related embodiment, as shown in FIG. 8, the subscriber server 706 can comprise:
a) a processor 802;
b) a non-transitory memory 804;
c) an input/output 806;
d) a subscriber form contract store 810, which can be configured to store the subscriber form contract 114 and the modified subscriber contract 116; and
e) a contract manager 814, which is configured to allow the contract partner 124 to accept the modified subscriber contract 116; all connected via
f) a data bus 820.

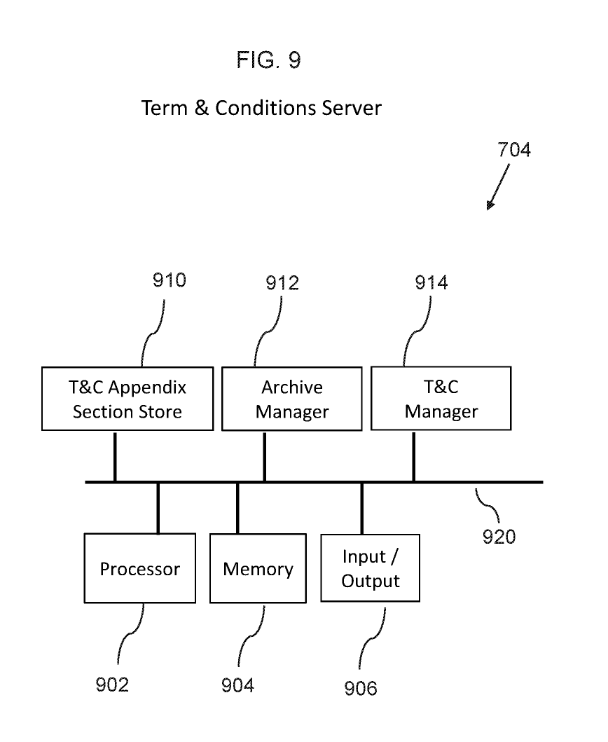

In a related embodiment, as shown in FIG. 9, the terms and conditions server 704 can comprise:
a) a processor 902;
b) a non-transitory memory 904;
c) an input/output 906;
d) a terms and conditions manager 914;
e) a terms and conditions appendix section store 910, which is configured to store a current version of the template terms and conditions appendix section 112; and
f) an archive manager 912, which is configured to store previous versions of the template terms and conditions appendix section 112;
wherein the terms and conditions manager 914 is configured to replace the current version of the template terms and conditions appendix section 112 in the terms and conditions appendix section store 910 with an updated version of the template terms and conditions appendix section 112;
wherein the terms and conditions manager 914 is configured to archive the current version of the template terms and appendix section 112 in the terms and conditions appendix section store 910, in communication with the archive manager.

In a related embodiment, the subscriber 122 can control the subscriber server 706 and determine what documents are stored in the subscriber form contract store 810. The subscriber form contract store 810 can be configured to store at least one subscriber form contract 114, and can be configured to store a version of the subscriber form contract 114 that has instantiated and incorporated a terms and conditions appendix section 112. In certain embodiments, a plurality of subscriber form contracts 114 and modified subscriber contracts 116 can be stored in the subscriber form contract store 810.

In a related embodiment, the contract manager 814 can be configured to receive an instantiated terms and conditions appendix section 112 from the terms and conditions appendix section store 210. In certain embodiments, the subscriber 122 can select a desired version of the terms and condition appendix section 112 to instantiate based on the type of business covered by the subscriber form contract 114.

In a related embodiment, the contract manager 814 can be configured to incorporate the terms and conditions appendix section 112 into the subscriber form contract 114 by modifying the subscriber form contract 114 by adding language, such as for example a sentence, to the subscriber form contract 114, which language references the template terms and conditions appendix section 112 stored on the terms and conditions server 704, for example by a name or UUID, with a version number string and/or date. By the language used in the included sentence, the template terms and conditions appendix section 112 can be incorporated into the subscriber form contract 114 by reference, thereby causing the terms and conditions appendix section 112 to function as the terms and conditions of the newly created modified subscriber contract 116 (e.g., “This contract hereby employs FairContract^{SM} Terms & Conditions v3.04.027 as the governing Terms and Conditions . . . ”).

In a related embodiment, the contract manager 814 can be configured to instantiate the terms and conditions appendix section 112 and add the full text of the instantiated terms and conditions appendix section 112 to the subscriber form contract 114. For example, the modified subscriber contract 116 can include the terms and conditions appendix section 112 in a subsection or an appendix of the modified subscriber contract 116.

In a related embodiment, the contract manager 814 can be configured to instantiate and incorporate a current version of the terms and conditions appendix section 112 from the terms and conditions appendix section store 210. In certain embodiments, the contract manager 214 can be configured to instantiate and incorporate a previous version of the terms and conditions appendix section 112 from the archive manager 212, depending on the preference of the contracting parties.

In a related embodiment, the contract manager 814 can be configured to allow users, such as the subscriber 122 and the contract partner 124, to view both current and archived versions of the terms and conditions appendix sections 112 via a network 130.

FIGS. 1-9 are block diagrams and flowcharts, methods, devices, systems, apparatuses, and computer program products according to various embodiments of the present invention. It shall be understood that each block or step of the block diagram, flowchart and control flow illustrations, and combinations of blocks in the block diagram, flowchart and control flow illustrations, can be implemented by computer program instructions or other means. Although computer program instructions are discussed, an apparatus or system according to the present invention can include other means, such as hardware or some combination of hardware and software, including one or more processors or controllers, for performing the disclosed functions.

In this regard, FIGS. 1-9 depict the computer devices of various embodiments, each containing several of the key components of a general-purpose computer by which an embodiment of the present invention may be implemented. Those of ordinary skill in the art will appreciate that a computer can include many components. However, it is not necessary that all of these generally conventional components be shown in order to disclose an illustrative embodiment for practicing the invention. The general-purpose computer can include a processing unit and a system memory, which may include various forms of non-transitory storage media such as random access memory (RAM) and read-only memory (ROM). The computer also may include nonvolatile storage memory, such as a hard disk drive, where additional data can be stored.

FIGS. 1 and 7 show depictions of embodiments of the contract management system 100 700, including the contract management server 102, the terms and conditions server 704, and the subscriber server 706. In this relation, a server shall be understood to represent a general computing capability that can be physically manifested as one, two, or a plurality of individual physical computing devices, located at one or several physical locations. A server can for example be manifested as a shared computational use of one single desktop computer, a dedicated server, a cluster of rack-mounted physical servers, a datacenter, or network of datacenters, each such datacenter containing a plurality of physical servers, or a computing cloud, such as Amazon EC2 or Microsoft Azure.

It shall be understood that the above-mentioned components of the contract management server 102, terms and conditions server 704 and the subscriber server 706 are to be interpreted in the most general manner.

For example, the processors 202 302 802 902, can each respectively include a single physical microprocessor or microcontroller, a cluster of processors, a datacenter or a cluster of datacenters, a computing cloud service, and the like.

In a further example, the non-transitory memory 204 304 804 904 can each respectively include various forms of non-transitory storage media, including random access memory and other forms of dynamic storage, and hard disks, hard disk clusters, cloud storage services, and other forms of long-term storage. Similarly, the input/output 206 306 806 906 can each respectively include a plurality of well-known input/output devices, such as screens, keyboards, pointing devices, motion trackers, communication ports, and so forth.

Furthermore, it shall be understood that the servers 102 704 706 and the contract management device 104 can each respectively include a number of other components that are well known in the art of general computer devices, and therefore shall not be further described herein. This can include system access to common functions and hardware, such as for example via operating system layers such as Windows, Linux, and similar operating system software, but can also include configurations wherein application services are executing directly on server hardware or via a hardware abstraction layer other than a complete operating system.

An embodiment of the present invention can also include one or more input or output components, such as a mouse, keyboard, monitor, and the like. A display can be provided for viewing text and graphical data, as well as a user interface to allow a user to request specific operations. Furthermore, an embodiment of the present invention may be connected to one or more remote computers via a network interface. The connection may be over a local area network (LAN) wide area network (WAN), and can include all of the necessary circuitry for such a connection.

In a related embodiment, the contract management device 104 communicates with the servers 102 704 706 over a network 130, which can include the general Internet, a Wide Area Network or a Local Area Network, or another form of communication network, transmitted on wired or wireless connections. Wireless networks can for example include Ethernet, Wi-Fi, Bluetooth, ZigBee, and NFC. The communication can be transferred via a secure, encrypted communication protocol.

Typically, computer program instructions may be loaded onto the computer or other general-purpose programmable machine to produce a specialized machine, such that the instructions that execute on the computer or other programmable machine create means for implementing the functions specified in the block diagrams, schematic diagrams or flowcharts. Such computer program instructions may also be stored in a computer-readable medium that when loaded into a computer or other programmable machine can direct the machine to function in a particular manner, such that the instructions stored in the computer-readable medium produce an article of manufacture including instruction means that implement the functions specified in the block diagrams, schematic diagrams or flowcharts.

In addition, the computer program instructions may be loaded into a computer or other programmable machine to cause a series of operational steps to be performed by the computer or other programmable machine to produce a computer-implemented process, such that the instructions that execute on the computer or other programmable machine provide steps for implementing the functions specified in the block diagram, schematic diagram, flowchart block or step.

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagrams, schematic diagrams or flowcharts, as well as combinations of blocks or steps, can be implemented by special purpose hardware-based computer systems, or combinations of special purpose hardware and computer instructions, that perform the specified functions or steps.

As an example, provided for purposes of illustration only, a data input software tool of a search engine application can be a representative means for receiving a query including one or more search terms. Similar software tools of applications, or implementations of embodiments of the present invention, can be means for performing the specified functions. For example, an embodiment of the present invention may include computer software for interfacing a processing element with a user-controlled input device, such as a mouse, keyboard, touch screen display, scanner, or the like. Similarly, an output of an embodiment of the present invention may include, for example, a combination of display software, video card hardware, and display hardware. A processing element may include, for example, a controller or microprocessor, such as a central processing unit (CPU), arithmetic logic unit (ALU), or control unit.

Here has thus been described a multitude of embodiments of the . . . device, and methods related thereto, which can be employed in numerous modes of usage.

The many features and advantages of the invention are apparent from the detailed specification, and thus, it is intended by the appended claims to cover all such features and advantages of the invention, which fall within the true spirit and scope of the invention.

For example, alternative embodiments can reconfigure or combine the components of the servers 102 704 706 and the contract management device 104. The components of the servers 102 704 706 can be distributed over a plurality of physical, logical, or virtual servers. Parts or all of the components of the contract management device 104 can be configured to operate in the servers 102 704 706, whereby the contract management device 104 for example can function as a thin client, performing only graphical user interface presentation and input/output functions. Alternatively, parts or all of the components of the servers 102 704 706 can be configured to operate in the contract management device 104.

Many such alternative configurations are readily apparent, and should be considered fully included in this specification and the claims appended hereto. Accordingly, since numerous modifications and variations will readily occur to those skilled in the art, the invention is not limited to the exact construction and operation illustrated and described, and thus, all suitable modifications and equivalents may be resorted to, falling within the scope of the invention.

What is claimed is:

1. A contract management system, comprising:
a contract management server, which is configured to store a template terms and conditions appendix section;
wherein the contract management server is configured to create a subscriber form contract, such that the contract management server is configured to incorporate the template terms and conditions appendix section into the subscriber form contract, thereby creating a modified subscriber contract;
wherein the contract management server is configured to create a completed contract when the modified subscriber contract is accepted by a contract partner.

2. The contract management system of claim 1, wherein the contract management server is configured to incorporate the template terms and conditions appendix section into the subscriber form contract by adding a sentence to the subscriber form contract, such that the sentence references the template terms and conditions appendix section.

3. The contract management system of claim 1, wherein the contract management server is configured to incorporate the template terms and conditions appendix section into the subscriber form contract by creating an instantiated terms and conditions appendix section, which is a copy of the template terms and conditions appendix section, such that the contract management server is configured to add the instantiated terms and conditions appendix section to the subscriber form contract.

4. The contract management system of claim 1, wherein the contract management server comprises:
a) a processor;
b) a non-transitory memory;
c) an input/output component;
d) a terms and conditions appendix section store, which is configured to store a current version of the template terms and conditions appendix section;
e) an archive manager, which is configured to store previous versions of the template terms and conditions appendix section; and
f) a contract manager; all connected via
g) a data bus.

5. The contract management system of claim 4, wherein the contract manager is configured to replace the current version of the template terms and conditions appendix section in the terms and conditions appendix section store with an updated version of the template terms and conditions appendix section; wherein the contract manager is configured to archive the current version of the template terms and appendix section in the terms and conditions appendix section store, in communication with the archive manager.

6. The contract management system of claim 4, wherein the contract manager is configured to receive an accept input from the contract partner to accept a terms and conditions amendment to the completed contract when the current version of the terms and conditions appendix section is updated, such that the contract manager is configured to update the completed contract with the terms and conditions amendment, to create an amended contract, when the contract manager has received the accept input.

7. The contract management system of claim 4, wherein the contract manager is configured to automatically update the completed contract with an updated version of the terms and condition appendix section when the current version of the terms and conditions appendix section is updated.

8. The contract management system of claim 1, further comprising a contract management device, which is connected to the contract management server, wherein the contract management device further comprises:
a) a processor;
b) a non-transitory memory;
c) an input/output; and
d) a contract controller, which is configured to allow the contract partner to view the modified subscriber contract and the completed contract; all connected via
e) a data bus.

9. The contract management system of claim 8, wherein the contract controller is configured to receive a contract accept input from the contract partner, when the contract partner accepts the modified subscriber contract.

10. The contract management system of claim 8, wherein the contract controller is configured to receive a subscriber accept input from the subscriber when the subscriber accepts the modified subscriber contract.

11. The contract management system of claim 8, wherein the contract controller is configured to receive a partner amendment accept input from the contract partner, when the contract partner accepts an amendment to the completed contract.

12. The contract management system of claim 8, wherein the contract controller is configured to receive a subscriber amendment accept input from the subscriber when the subscriber accepts an amendment to the completed contract.

13. A contract management system, comprising:
a) a terms and conditions server, which is configured to store a template terms and conditions appendix section; and
b) a subscriber server, which is configured to create and store a subscriber form contract, wherein the subscriber server is connected to the terms and conditions server;
wherein the subscriber server is configured to create the subscriber form contract, such that the subscriber server is configured to incorporate the template terms and conditions appendix section into the subscriber form contract, thereby creating a modified subscriber contract;
wherein the subscriber server is configured to create a completed contract when the modified subscriber contract is accepted by a contract partner.

14. The contract management system of claim 13, wherein the subscriber server further comprises:
a) a processor;
b) a non-transitory memory;
c) an input/output;
d) a subscriber form contract store, which is configured to store the subscriber form contract and the modified subscriber contract; and
e) a contract manager, which is configured to allow the contract partner to accept the modified subscriber contract; all connected via
f) a data bus.

15. The contract management system of claim 13, wherein the terms and conditions server further comprises:
a) a terms and conditions manager;
b) a terms and conditions appendix section store, which is configured to store a current version of the template terms and conditions appendix section; and
c) an archive manager, which is configured to store previous versions of the template terms and conditions appendix section;
wherein the terms and conditions manager is configured to replace the current version of the template terms and conditions appendix section in the terms and conditions appendix section store with an updated version of the template terms and conditions appendix section; and
wherein the terms and conditions manager is configured to archive the current version of the template terms and appendix section in the terms and conditions appendix section store, in communication with the archive manager.

16. A computer-implemented method for managing contracts, comprising:
a) selecting form contract, comprising selecting a desired subscriber form contract;
b) incorporating terms and conditions, comprising adding language to the subscriber form contract incorporating a current version of a terms and conditions appendix section into the subscriber form contract, thereby creating a modified subscriber contract;
c) presenting modified contract, comprising presenting the modified subscriber contract to a subscriber and a contract partner for review; and
d) accepting modified contract, comprising receiving partner acceptance of the modified subscriber contract from the contract partner, and then creating a completed contract.

17. The computer-implemented method for managing contracts of claim 16, further comprising receiving subscriber acceptance of the modified subscriber contract from the subscriber, prior to obtaining partner acceptance.

18. The computer-implemented method for managing contracts of claim 16, further comprising:
a) prompting the contract partner to accept an amendment to the completed contract when an updated version of the terms and conditions appendix section is released; and
b) receiving acceptance of an amendment to the completed contract from the contract partner, and then replacing the current version of the terms and conditions appendix section in the completed contract with the updated version of the terms and conditions appendix section.

19. The computer-implemented method for managing contracts of claim 16, further comprising:
a) adding language to the subscriber form contract to specify that an updated version of the terms and conditions appendix section is automatically incorporated into the completed contract upon release; and
b) automatically incorporating the updated version of the terms and conditions appendix section into the completed contract.

20. The computer-implemented method for managing contracts of claim 16, further comprising:
a) reviewing terms and conditions, comprising reviewing the current version of the terms and conditions appendix section;
b) revising terms and conditions, comprising revising the current version of the terms and conditions appendix section, thereby creating an updated version of the terms and conditions appendix section;
c) archiving current terms and conditions, comprising archiving the current version of the terms and conditions appendix section; and
d) releasing updated terms and conditions, comprising releasing the updated version of the terms and conditions appendix section, such that the updated version of the terms and conditions appendix section becomes the current version of the terms and conditions appendix section.
